(19) United States
(12) Patent Application Publication
(10) Pub. No.: US 2009/0245767 A1
(43) Pub. Date: Oct. 1, 2009

(54) LENS ASSEMBLY AND IMAGING DEVICE

(76) Inventors: Yuya Sakai, Saitama-shi (JP); Koichi Kato, Saitama-shi (JP)

Correspondence Address: BIRCH STEWART KOLASCH & BIRCH, PO BOX 747, FALLS CHURCH, VA, 22040-0747, US

(21) Appl. No.: 12/404,058

(22) Filed: Mar. 13, 2009

(30) Foreign Application Priority Data
Mar. 28, 2008 (JP) P2008-088525

(51) Int. Cl. G03B 17/08; G02B 23/16

(52) U.S. Cl. 396/25; 359/513

(57) ABSTRACT

A lens assembly is provided and includes: a plurality of lenses including a first lens located nearest to an object side of the lens assembly and a second lens located adjacent to the first lens; and a lens frame having a hollow part which includes an opening on each of an object side and an image forming side of the lens assembly and into which the plurality of lenses are inserted with their optical axes aligned. Liquid is sealed in a part between the first lens and the second lens.

This application is based on and claims priority under 35 U.S.C §119 from Japanese Patent Application No. 2008-088525, filed on Mar. 28, 2008, the entire disclosure of which is herein incorporated by reference.

### BACKGROUND OF THE INVENTION

1. Field of the Invention

The present invention relates to a lens assembly having a preventing function for preventing a vapor condensation from occurring and an imaging device having the lens assembly.

2. Description of Related Art

Recently, motor vehicles have been equipped with cameras. Most of the cameras employ circumstances that navigation systems are popularized and display screens are provided in driver's seats to display the states of places of the dead angle for the drivers on the display screens.

In such a camera to be mounted on a vehicle, since a lens located at a part nearest to the object side is arranged to be exposed to the surface of a vehicle body, a strict waterproof performance is required. Accordingly, in most of lens assemblies to be mounted on the vehicle, an O ring is inserted into a part between the outer peripheral surface of the lens located at the part nearest to the object side and the inner peripheral surface of a lens frame to prevent the entry of water.

However, even when the O ring is used to prevent the entry of the water, since the lens located at the part nearest to the object side directly receives the influence of an external temperature change, if a space is formed in a rear surface of the lens, a problem still arises that a vapor condensation is liable to occur in the rear surface side of the lens.

Thus, a technique is proposed that nitrogen gas is sealed in a lens frame to prevent a vapor condensation from occurring, a heater is incorporated to prevent a vapor condensation from occurring or a vent port is provided in a lens frame to prevent the generation of a vapor condensation (for instance, see JP-A-2006-023421, JP-A-6-258713, and JP-A-2007-193319).

However, in a structure that the nitrogen gas is sealed in the lens frame, since an assembling work needs to be carried out in a room filled with the nitrogen gas, a problem arises that the assembling work is complicated. Further, in a structure in which that the heater is incorporated, a problem arises that a space for incorporating the heater is required to enlarge a lens frame. Further, when the vent port is provided, a problem arises that dust may possibly enter and adhere to the surface of a lens.

### SUMMARY OF THE INVENTION

An object of an illustrative, non-limiting embodiment of the present invention is to provide a lens assembly having a structure in which when a space is formed in a rear surface side of a lens located at a part nearest to the object side, a vapor condensation hardly occurs on the surface of the lens in contact with the space and a dustproof function and an imaging device having the lens assembly.

According to an aspect of the invention, there is provided a lens assembly including:

a plurality of lenses including a first lens located nearest to an object side of the lens assembly and a second lens located adjacent to the first lens; and

a lens frame having a hollow part which includes an opening on each of an object side and an image forming side of the lens assembly and into which the plurality of lenses are inserted with their optical axes aligned,

wherein liquid is sealed in a part between the first lens and the second lens.

According to the lens assembly, the liquid is sealed in the part between the first lens located nearest to the object side among the plurality of lenses inserted into the hollow part and the second lens adjacent to the first lens, so as to prevent a vapor condensation. Further, since the liquid is sealed, dust is also prevented from entering the part between the first lens and the second lens from an external part to adhere to the surfaces of the lenses.

Here, the above-described liquid may be any liquid that does not give an adverse effect to the optical performance of the lenses from the viewpoint of prevention of a vapor condensation. For instance, when a fact that the lens assembly is used under various environments is considered, a non-freezing solution that does not freeze even in a cold district may be supposed to be used.

Here, the first lens may be a glass lens.

As described above, when the liquid is sealed to the part between the first lens and the second lens, even if the glass lens good in its thermal conductivity is used as the lens in the object side, the vapor condensation is prevented from occurring. Thus, when the glass lens is used, an effect is obtained that the lens is stronger to wind and rain than a plastic lens and a weather resistance is improved.

A peripheral edge part of the image forming side surface of the first lens and a peripheral edge part of the object side surface of the second lens may come into contact with each other around the peripheral edge part and have a cavity part between the first lens and the second lens in a central part surrounded by the peripheral edge part, and the liquid may be sealed in the cavity part.

When the first lens and the second lens respectively have the peripheral edge parts that come into contact with each other, a space can be sealed by the lenses. The space is filled with the liquid so that the vapor condensation can be prevented from occurring on both the image forming side surface of the first lens and the object side surface of the second lens.

Further, a first O ring may be provided between the first lens and an inner wall of the hollow part, a second O ring may be provided between the second lens and the inner wall of the hollow part, and the liquid may be sealed between the first O ring and the second O ring.

In such a way, the space formed between the first lens and the second lens is sealed by the first and second O rings to more prevent both the entry of water to the space and the flow-out of the liquid from the space.

An imaging device according an aspect of the invention: the above-described lens assembly and an imaging element.

According to the imaging device, since the lens assembly having the structure in which the vapor condensation is prevented from occurring is incorporated in the imaging device, the imaging device can be realized that can achieve a comfortable shooting operation even in any shooting environment.

### BRIEF DESCRIPTION OF THE DRAWINGS

The features of the invention will appear more fully upon consideration of the exemplary embodiment of the invention, which are schematically set forth in the drawings, in which:

FIG. 1 is a diagram showing a structure of a lens assembly 1 according to an exemplary embodiment of the present invention; and

FIG. 2 is a diagram showing a camera unit 2 having the lens assembly 1 shown in FIG. 1.

### DETAILED DESCRIPTION OF THE EXEMPLARY EMBODIMENTS

According to an exemplary embodiment of the present invention, it is possible to provide a lens assembly having the structure in which when a space is formed in the rear surface side of the lens located at the part nearest to the object side, the vapor condensation hardly occurs in the part in contact with the space and a dustproof function, and to provide an imaging device having the lens assembly.

Now, an exemplary embodiment of the present invention will be described below.

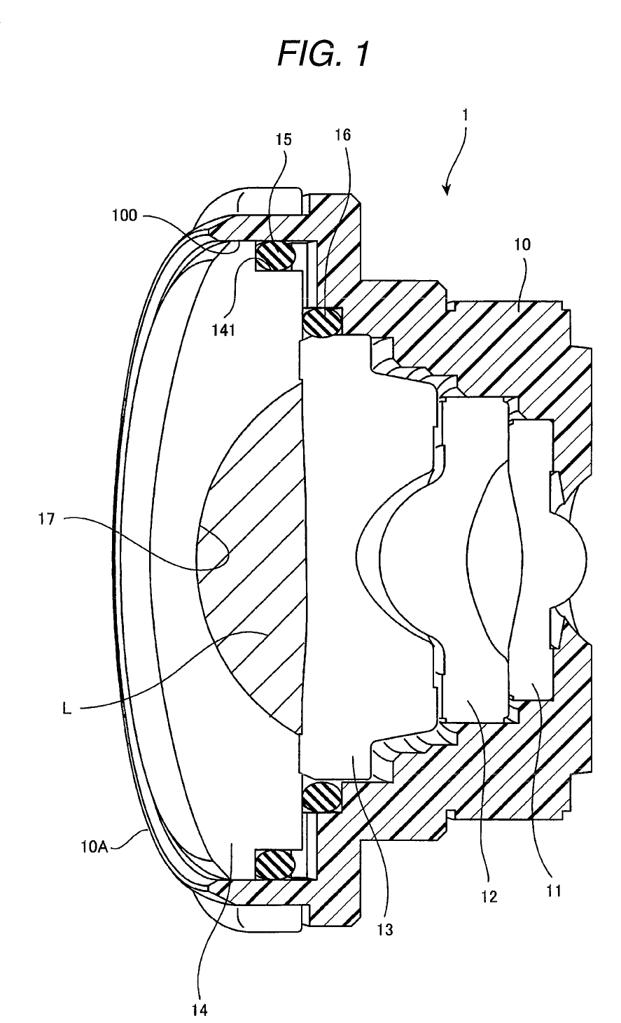

FIG. 1 is a diagram showing the structure of a lens assembly 1 of an exemplary embodiment of the present invention.

FIG. 1 shows the lens assembly 1 including four lenses 11 to 14 and a lens frame 10 with a hollow part having an object side opening and an image forming side opening and into which the four lenses 11 to 14 are inserted with their optical axes aligned.

FIG. 1 shows, in order to easily obtain a dustproof performance or a waterproof performance, an example of a structure in which the lenses 11 to 14 are respectively inserted into the lens frame 10 with the outer peripheral edges of the lenses coming into contact and their optical axes aligned, and the lenses 11 to 14 are formed so that as the lenses come nearer to an object side, the diameters of the lenses become larger.

In such a structure as shown in FIG. 1, when an O ring 15 (refer it to as a first O ring, hereinafter) is mounted between an outer peripheral surface 141 of the first lens 14 located at a part nearest to the object side and an inner wall surface 100 of the lens frame, an excellent waterproof performance and a dustproof performance can be obtained.

However, in the case of the structure shown in FIG. 1, since a cavity part 17 is formed between the first lens 14 located at the part nearest to the object side and a second lens 13 adjacent to the first lens, a vapor condensation may be liable to occur. Further, in this embodiment, since the lens assembly is supposed to be used and mounted on a vehicle so that a glass lens having a weather resistance is employed as the lens 14 located at the part nearest to the object side, the vapor condensation may be more liable to occur in the cavity part 17.

Thus, this embodiment proposes a structure that the cavity part 17 formed between the first lens 14 of the four lenses 11 to 14 inserted into the hollow part of the lens frame 10 of the lens assembly 1 shown in FIG. 1 that is located at the part nearest to the object side and the second lens 13 adjacent to the first lens 14 is filled with liquid L, so as to prevent the occurrence of the vapor condensation both in the first lens 14 in an image forming side and the second lens 13 in the object side. In this embodiment, when the assembly of the second lens 13 is finished, the lens frame 10 is filled with the liquid, and then, the first lens 14 is mounted to seal the liquid L in the cavity part 17. In such a way, since a liquid inlet port communicating with an external part does not need to be provided, the excellent dustproof performance can be obtained.

Further, the above-described liquid may be any liquid that does not give an adverse effect to the optical performance of the lenses from the viewpoint of the prevention of the vapor condensation. For instance, when a fact that the lens assembly is used under various environments is considered, a non-freezing solution or alcohol that does not freeze even in a cold district may be supposed to be used. According to this structure, since the surfaces of the lenses coming into contact with the cavity part 17 formed between the first lens and the second lens are constantly wetted with the liquid, the occurrence of the vapor condensation is prevented.

Further, in this embodiment, in order to prevent the leakage of the liquid L to an external part, a second O ring 16 is arranged between the second lens 13 and the inner wall surface 100 of the hollow part in addition to the first O ring 15 to seal the liquid L by the first O ring 15 and the second O ring 16.

According to this structure, not only the entry of water from the external part is prevented by the originally provided O ring 15, but also the leakage of the liquid L with which the cavity part 17 is filled is prevented both by the first O ring and the second O ring.

In such away, when a place where the vapor condensation is most liable to occur is filled with the liquid L to prevent the vapor condensation, since a vent port communicating with the external part does not need to be provided as described above, not only a function for preventing the vapor condensation, but also a dustproof function can be effectively obtained.

As described above, is realized the lens assembly having a structure in which when a space is formed in the rear surface side of the lens located at the part nearest to the object side, the vapor condensation does not absolutely occur on the surfaces of the lenses in contact with the space and also having a dustproof function.

In the above-described embodiment, the structure is shown in which the second O ring 16 is provided to seal the liquid L in the cavity part 17 formed between the first lens 14 and the second lens 13. However, the second O ring 16 may not be provided and the outer peripheral edge surfaces of the first lens 14 and the second lens 13 may be bonded and fixed to each other. Further, as a material of the first and second O rings, ethylene propylene rubber, silicon rubber or the like may be used.

Now, a method for assembling the lens assembly 1 shown in FIG. 1 will be briefly described below.

Three lenses 11 to 13 are respectively inserted in order into the lens frame 10 shown in FIG. 1. Before the lens 14 located at the part nearest to the object side is inserted, a part into which the lens 14 is inserted is directed upward to fill the part with the non-freezing solution, and then, the lens 14 is inserted. Further, a front end part 10A of the lens frame 10 is bent by a thermally caulking operation so that the lens 14 does not slip out. Thus, the lens assembly 1 is completed.

In the lens assembly 1 completed in such a way, the cavity part 17 shown in FIG. 1 is filled with the non-freezing solution L, so that the vapor condensation hardly occurs both in the image forming side surface of the lens 14 located at the part nearest to the object side and the object side surface of the lens located in the object side subsequently to the lens 14.

When the lens assembly 1 is incorporated in a camera, the camera is very strong to the vapor condensation.

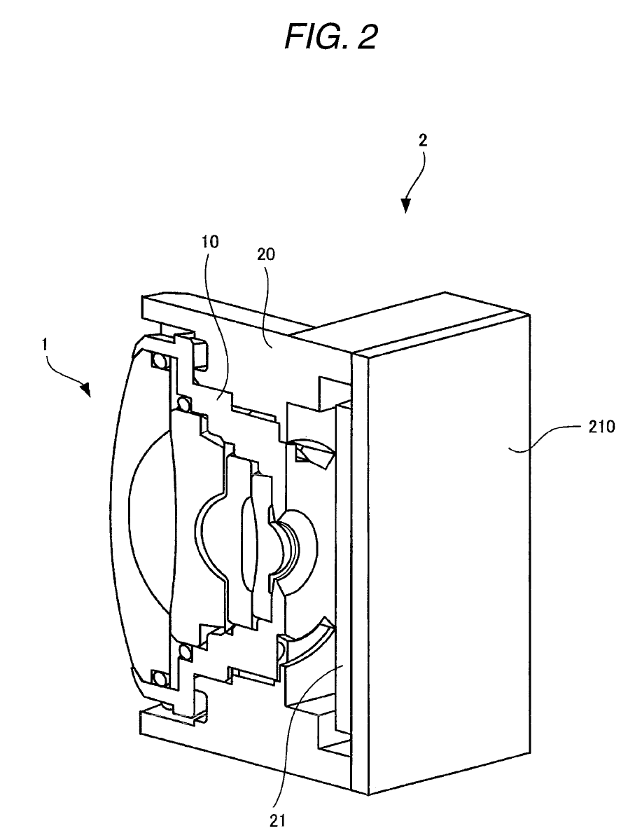

FIG. 2 is a diagram showing a camera unit 2 provided with the lens assembly 1 shown in FIG. 1.

FIG. 2 is a diagram showing a surface of the camera unit 2 taken along an optical axis seen from an obliquely upper part.

The camera unit 2 shown in FIG. 2 includes the lens assembly 1 shown in FIG. 1, a camera main body frame 20 and an imaging element 21. The imaging element 21 is mounted on a base board 210 of the imaging element and stuck and fixed to the camera main body frame 20.

When the camera unit 2 is assembled, the lens assembly 1 shown in FIG. 1 is initially inserted into the camera main body frame 20 of the camera unit 2 to stick and fix the lens assembly 1 to the camera main body frame 20. At this time, an adhesive agent is applied to a part between the outer peripheral edge of a front end of a lens frame 10 and the inner peripheral edge of a front end of the camera main body frame 20 to carry out a waterproof process so that water does not enter an inner part of the camera unit from a front end side. Further, the base board 210 on which the imaging element 21 such as a CCD solid state imaging element is mounted may be stuck and fixed to the camera main body frame 20 to obtain the camera unit 2 shown in FIG. 2.

In such a way, when the lens assembly 1 shown in FIG. 1 is incorporated in the camera unit 2, the camera unit very strong to the vapor condensation is manufactured and preferably applied to a motor vehicle.

What is claimed is:

1. A lens assembly comprising:
a plurality of lenses including a first lens located nearest to an object side of the lens assembly and a second lens located adjacent to the first lens; and
a lens frame having a hollow part which includes an opening on each of an object side and an image forming side of the lens assembly and into which the plurality of lenses are inserted with their optical axes aligned,
wherein liquid is sealed in a part between the first lens and the second lens.

2. The lens assembly according to claim 1, wherein the first lens is a glass lens.

3. The lens assembly according to claim 1, wherein
a peripheral edge part of the image forming side surface of the first lens and a peripheral edge part of the object side surface of the second lens come into contact with each other around the peripheral edge part and have a cavity part between the first lens and the second lens in a central part surrounded by the peripheral edge part, and
the liquid is sealed in the cavity part.

4. The lens assembly according to claim 1, further comprising a first O ring provided between the first lens and an inner wall of the hollow part, and a second O ring provided between the second lens and the inner wall of the hollow part,
wherein the liquid is sealed between the first O ring and the second O ring.

5. The lens assembly according to claim 2, further comprising a first O ring provided between the first lens and an inner wall of the hollow part, and a second O ring provided between the second lens and the inner wall of the hollow part,
wherein the liquid is sealed between the first O ring and the second O ring.

6. An imaging device comprising: a lens assembly according to any claim 1, and an imaging element.

7. An imaging device comprising: a lens assembly according to any claim 2, and an imaging element.

8. An imaging device comprising: a lens assembly according to any claim 3, and an imaging element.

9. An imaging device comprising: a lens assembly according to any claim 4, and an imaging element.

10. An imaging device comprising: a lens assembly according to any claim 5, and an imaging element.
